(19) United States
(12) Patent Application Publication
(10) Pub. No.: US 2026/0358141 A1
(43) Pub. Date: Nov. 12, 2026

(54) METHOD FOR DETERMINING A MISALIGNMENT OF AN INERTIAL MEASUREMENT UNIT OF A VEHICLE, AND VEHICLE COMPRISING AN INERTIAL MEASUREMENT UNIT

(71) Applicants: Mercedes-Benz Group AG, Stuttgart (DE); Marelli Germany GbmH, Reutlingen (DE)

(72) Inventors: Sinan YARGELDI, Dettingen (DE); Anton NELSON, Ammerbuch (DE); Davide BACCARIN, Reutlingen (DE)

(21) Appl. No.: 19/125,796

(22) PCT Filed: Oct. 13, 2023
(86) PCT No.: PCT/EP2023/078504

§ 371 Date: Apr. 30, 2025

(30) Foreign Application Priority Data
Nov. 1, 2022 (DE) 10 2022 128 870.6

(51) Int. Cl. G01C 25/00; G01C 21/16; G01P 15/18; G01P 21/00

(52) U.S. Cl. CPC G01C 25/005; G01C 21/166; G01P 15/18; G01P 21/00

(57) ABSTRACT

A method for determining a misorientation of a sensor coordinate system of an inertial measuring unit of a vehicle with respect to a vehicle coordinate system during a driving operation of the vehicle in a plurality of iteration stages. The respective iteration stage may have actual measured values of a longitudinal acceleration and lateral acceleration determined by the inertial measuring unit, the acceleration due to gravity, state data required for calculating inertial forces and coefficients of predetermined polynomials. The inertial forces are calculated in the respective iteration stage, the measured values of the longitudinal acceleration and lateral acceleration are adjusted, the coefficients of the polynomials are updated, the iterations being terminated when the zero-order coefficients of the polynomials fulfill a respective predetermined convergence criterion and the zero-order coefficients of the polynomials are output as results of the determined misorientation of the sensor coordinate system.

The invention relates to a method for determining a misorientation of an inertial measuring unit of a vehicle according to the features of the generic term of claim 1 and to a vehicle.

As described in DE 10 2005 033 237 A1, a method for determining and correcting misorientations and offsets of the sensors of an inertial measurement unit in a land vehicle is known from the state of the art. The inertial measurement unit contains three linear acceleration sensors and three angular rate sensors. The desired installation directions for the sensors are parallel to the coordinate axes of a Cartesian coordinate system fixed to the vehicle. The actual installation directions of the sensors can deviate from the desired installation directions due to error orientations. The actual installation directions of the linear acceleration sensors are determined by comparing the accelerations measured by the linear acceleration sensors in different positions of the vehicle with the acceleration values known for these different positions in the Cartesian coordinate system fixed to the vehicle. A coordinate transformation can then be used to convert the measured accelerations into the actual accelerations.

The object of the invention is to provide a method for determining a misorientation of an inertial measurement unit of a vehicle that is improved compared to the prior art and a vehicle that is improved compared to the prior art.

The object is achieved according to the invention by a method for determining a misorientation of an inertial measuring unit of a vehicle with the features of claim 1 and a vehicle with the features of claim 6.

Advantageous embodiments of the invention are the subject of the subclaims.

In a method for determining a misorientation of an inertial measuring unit of the vehicle, which is provided in particular for measuring an acceleration of a vehicle and by means of which three-dimensional components of the acceleration of the vehicle are measured in a sensor coordinate system, it is provided that a vehicle coordinate system is specified for the vehicle, which has an x-axis, also referred to as roll axis, in the longitudinal direction of the vehicle, a y-axis, also referred to as pitch axis, in the transverse direction of the vehicle and a z-axis, also referred to as yaw axis, in the vertical direction of the vehicle. In the method, a misorientation of a plane spanned between an x-axis and a y-axis of the sensor coordinate system is determined relative to a plane spanned between the x-axis and the y-axis of the vehicle coordinate system, i.e. the misorientation of the sensor coordinate system relative to the roll axis, i.e. the x-axis, and relative to the pitch axis, i.e. the y-axis, of the vehicle coordinate system is determined.

According to the invention, the misorientation is determined iteratively in several iteration stages while the vehicle is moving, i.e. while the vehicle is in motion. The respective iteration stage receives input, i.e. input values:
current measured values determined by the inertial measurement unit, in particular measured values of a longitudinal acceleration and a lateral acceleration of the vehicle,
the acceleration due to gravity,
state data of the vehicle required for calculating inertial forces, in particular a Coriolis force, a centripetal force and/or an Euler force, in particular a rotational speed of the vehicle, a rotation rate of the vehicle, a speed of the vehicle and/or wheel rotational speeds of wheels of the vehicle, and
coefficients of predetermined polynomials, each of which represents an approximated relationship between the measured longitudinal acceleration and a pitch angle of the vehicle or between the measured lateral acceleration and a roll angle of the vehicle, i.e. one polynomial represents an approximated relationship between the measured longitudinal acceleration and the pitch angle of the vehicle and the other polynomial represents an approximated relationship between the measured lateral acceleration and the roll angle of the vehicle. The specified polynomials are in particular first or second order polynomials. In particular, these coefficients are parameters that are iteratively refined in the individual iteration stages based on predefined starting values.

The acceleration due to gravity is calculated in particular using the other inputs mentioned above, for example using a Kalman filter.

In the respective iteration stage, the inertial forces, in particular the Coriolis force, the centripetal force and/or the Euler force, are calculated and the measured values of the longitudinal acceleration and lateral acceleration are adjusted for contributions that originate from the acceleration due to gravity and from the inertial forces, i.e. are caused by these. Furthermore, the coefficients of the polynomials are updated with the adjusted measured values of the longitudinal acceleration and lateral acceleration in the respective iteration stage.

In each iteration stage, the system checks whether the zero-order coefficients of the polynomials fulfill a specified convergence criterion.

If the zero-order coefficients of the polynomials do not fulfill the respective specified convergence criterion, the coefficients of the polynomials are output to the next iteration stage and used there as input values.

Otherwise, i.e. if the zero-order coefficients of the polynomials fulfill the respective specified convergence criterion, the iterations are terminated, i.e. no further iteration steps are performed.

At the end of the iterations, the zero-order coefficients of the polynomials are output as results of the determined misorientation of the sensor coordinate system, i.e. as results of the determined misorientation of the plane spanned between the x-axis and the y-axis of the sensor coordinate system relative to the plane spanned between the x-axis and the y-axis of the vehicle coordinate system, i.e. as results of the determined misorientation of the sensor coordinate system relative to the roll axis, i.e. the x-axis, and relative to the pitch axis, i.e. the y-axis, of the vehicle coordinate system. The zero-order coefficients correspond to a static pitch angle or a static roll angle and represent the misorientation of the sensor coordinate system with respect to the pitch axis, i.e. the y-axis, or the roll axis, i.e. the x-axis, of the vehicle coordinate system. That is, the zero-order coefficient of one polynomial corresponds to the static pitch angle and represents the misorientation of the sensor coordinate system with respect to the pitch axis of the vehicle coordinate system, and the zero-order coefficient of the other polynomial corresponds to the static roll angle and represents the misorientation of the sensor coordinate system with respect to the roll axis of the vehicle coordinate system.

This misalignment of the sensor coordinate system of the inertial measurement unit in relation to the specified vehicle coordinate system can be caused, for example, by installation tolerances when installing the inertial measurement unit in the vehicle and/or manufacturing tolerances of the inertial measurement unit.

In one possible embodiment of the method, the results of the determined misorientation of the sensor coordinate system (static pitch angle and static roll angle) are used to create a coordinate transformation matrix with which the three-dimensional components of the acceleration determined in the sensor coordinate system are or can be converted into the vehicle coordinate system. In this way, the inertial measurement unit is calibrated, i.e. measurement errors caused by the misorientation of the sensor coordinate system are compensated for. This embodiment of the method is therefore in particular a method for calibrating the inertial measurement unit of the vehicle.

Using the method described, only the misalignments in relation to the roll axis and pitch axis are determined. The misalignment in relation to the yaw axis is not determined. If necessary, it can be determined using a different method, particularly retrospectively. The calibration therefore only corrects the misalignment of the inertial measurement unit relative to the roll axis and pitch axis of the vehicle. However, this is already sufficient for some applications, for example for headlight range control of the vehicle's headlights, because for this headlight range control it is sufficient that the x-y plane of the sensor coordinate system, i.e. the plane spanned between the x-axis and the y-axis of the sensor coordinate system, is aligned parallel to the x-y plane of the vehicle coordinate system, i.e. parallel to the plane spanned between the x-axis and the y-axis of the vehicle coordinate system. For headlamp range control, it is particularly important that the vehicle headlamps do not shine too low or too high. This is ensured by the solution described. A rotation of the sensor coordinate system relative to the vehicle coordinate system about the yaw axis is irrelevant for headlamp range control, as it is not relevant for headlamp range control whether the vehicle headlamps shine too far to the left or right.

In particular, the solution described enables automatic self-calibration of the inertial measurement unit.

The inertial measurement unit can be used in the vehicle for numerous functions, for example for the aforementioned headlight range control, airbag control, an electronic stability program ESP, dead reckoning, i.e. dead reckoning, and/or for ego-motion estimation, i.e. estimating the movement of the vehicle. For these applications, it is important that the orientation of the inertial measurement unit, in particular its sensor coordinate system, to the vehicle coordinate system is as correct as possible. When manufacturing the inertial measurement unit and installing it in the vehicle, care is therefore taken to minimize a chain of errors resulting from the positioning of sensors, in particular acceleration sensors, on a circuit board of the inertial measurement unit, the positioning of the circuit board in a housing of the inertial measurement unit, the attachment of the inertial measurement unit to a body of the vehicle and body deformations. Nevertheless, this has so far resulted in a misalignment, i.e. a misorientation of the inertial measuring unit, of +−3°. The method described enables simple and automatic calibration of the inertial measurement unit already installed in the vehicle. No additional hardware components are required for the method described. Furthermore, the method described does not require any additional processing steps on a production line during production of the vehicle. The method enables significantly better calibration and therefore significantly higher accuracies; in particular, a sensor offset is insignificant for the calibration accuracy.

A vehicle according to the invention has the inertial measurement unit and a device that is designed and set up to carry out the method. The vehicle according to the invention thus has the same advantages as the method described above.

In one possible embodiment, the device or at least one processing unit of the device is a component of the inertial measurement unit. This enables, in particular, the automatic self-calibration of the inertial measurement unit already mentioned above. In particular, the processing unit of the device is designed and set up to carry out the processing operations described above, in particular calculations and determinations.

In one possible embodiment, the device has sensors for determining the acceleration due to gravity and/or the vehicle status data required for calculating the inertial forces. For example, the respective sensor is a sensor already installed in the vehicle for other purposes. In this embodiment, the device thus has, in particular, the sensors and the processing unit, wherein the sensors provide the processing unit with corresponding sensor data, which is processed in the processing unit in the method described above in the manner described.

Examples of embodiments of the invention are explained in more detail below with reference to drawings.

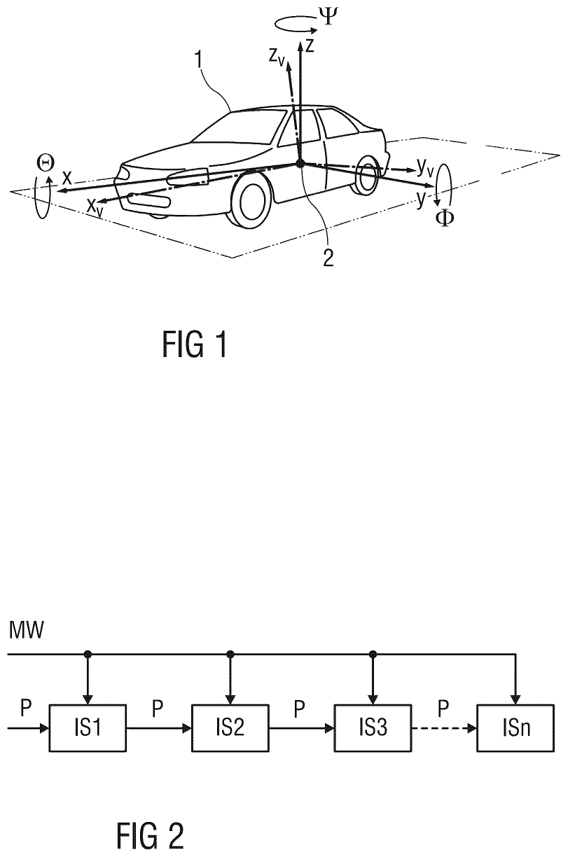

FIG. 1 schematically shows a vehicle with an inertial measurement unit, and

FIG. 2 schematic shows the course of a procedure for determining a misalignment of the vehicle's inertial measurement unit.

Corresponding parts are marked with the same reference signs in all figures.

FIG. 1 shows a schematic representation of a vehicle 1 with an inertial measurement unit 2, also known as an IMU (inertial measurement unit), acceleration sensor or acceleration sensor unit. The inertial measurement unit 2 is intended in particular for measuring the acceleration of the vehicle 1. The vehicle 1 also has a device which is designed and set up to carry out a method for determining a misalignment of the inertial measurement unit 2. This device or at least one processing unit of the device is, for example, a component of the inertial measurement unit 2.

FIG. 2 shows a schematic representation of a course of the procedure for determining the misalignment of the inertial measurement unit 2.

The inertial measurement unit 2 is intended to be used to determine three-dimensional components of the acceleration of the vehicle 1 in a vehicle coordinate system that is fixed to the vehicle. This is required for various vehicle functions, for example for an ABS function (ABS=anti-lock braking system), ESP function (ESP=electronic stability program) and/or headlamp range control.

As shown in FIG. 1, the predefined vehicle coordinate system has an x-axis, also known as the roll axis X_{V}, in the longitudinal direction of the vehicle, a y-axis, also known as the pitch axis Y_{V}, in the transverse direction of the vehicle and a z-axis, also known as the yaw axis Z_{V}, in the vertical direction of the vehicle. The origin of the predetermined vehicle coordinate system is located, in particular, in a center of gravity of the vehicle 1. The predetermined vehicle coordinate system is, in particular, fixed with respect to a body of the vehicle 1. In particular, the yaw axis Z_{V} runs upwards parallel to a normal vector of a cabin floor and cabin roof of the vehicle 1. The roll axis X_{V} runs in particular parallel to the longitudinal axis of the vehicle and thus perpendicular to the normal vector of the cabin floor and cabin roof of the vehicle 1. The pitch axis Y_{V} runs in particular parallel to the transverse axis of the vehicle and thus perpendicular to the normal vector of the cabin floor and cabin roof of the vehicle 1.

In fact, the inertial measurement unit 2 measures three-dimensional components of the acceleration of the vehicle 1 in a sensor coordinate system of the inertial measurement unit 2. The sensor coordinate system has an x-axis X, a y-axis Y and a z-axis Z. The sensor coordinate system has a misalignment relative to the specified vehicle coordinate system, for example due to installation tolerances and/or manufacturing tolerances, i.e. it is rotated relative to the vehicle coordinate system. In other words: the sensor coordinate system is rotated relative to the pitch axis Y_{V} of the vehicle 1 by a static pitch angle Φ, rotated relative to the roll axis X_{V} of the vehicle 1 by a static roll angle Θ and rotated relative to the yaw axis Z_{V} of the vehicle 1 by a static yaw angle Ψ.

In the method, a misorientation of a plane spanned between the x-axis X and the y-axis Y of the sensor coordinate system relative to a plane spanned between the roll axis X_{V} and the pitch axis Y_{V} of the vehicle coordinate system is determined, in particular by means of the device, in particular by means of the processing unit of the device, i.e. the misorientation of the sensor coordinate system relative to the roll axis X_{V} and relative to the pitch axis Y_{V} of the vehicle coordinate system and thus the static roll angle Θ and the static pitch angle Φ are determined. Using these angles Θ, Φ measured values MW of the inertial measurement unit 2 recorded in the sensor coordinate system are then converted into the vehicle coordinate system by means of a coordinate transformation. This conversion calibrates the inertial measurement unit 2 to the vehicle coordinate system.

The misalignment, i.e. the static pitch angle Φ and the static roll angle Θ, is determined iteratively during travel in several iteration stages IS1 to ISn, as shown in FIG. 2.

The respective iteration stage IS1 to ISn receives as input, i.e. as input values, current measured values MW of the inertial measurement unit 2, i.e. current measured values MW of a longitudinal acceleration a_{x,roh} and a lateral acceleration a_{y,roh} of the vehicle 1 determined by means of the inertial measuring unit 2, and also the acceleration due to gravity g and status data of the vehicle 1 required for calculating inertial forces, in particular a Coriolis force, a centripetal force and/or an Euler force, in particular a rotational speed of the vehicle 1, a rotation rate of the vehicle 1, a speed of the vehicle 1 and/or wheel rotational speeds of wheels of the vehicle 1. The device advantageously has corresponding sensors for this purpose. These sensors can, for example, be sensors already present in the vehicle 1 and, in particular, sensors intended for other vehicle applications.

In addition, the respective iteration stage IS1 to ISn receives as input, i.e. as input values, coefficients Φ₀, Φ₁, Θ₂, Θ₀, Θ₁, Θ₂ of predetermined polynomials, in particular of first or second order polynomials, which in each case represent an approximated relationship between the measured longitudinal acceleration a_{x,roh} and the pitch angle Φ of the vehicle 1 or between the measured lateral acceleration a_{y,roh} and the roll angle Θ of the vehicle 1. These coefficients are parameters P, which are iteratively refined in the individual iteration stages IS1 to ISn, starting from predefined initial values. The starting values are therefore the parameters P, i.e. the coefficients Φ₀, Φ₁, Φ₂, Θ₀, Θ₁, Θ₂, for the first iteration stage IS1.

In the respective iteration stage IS1 to ISn, the inertial forces are calculated and the measured values MW of the longitudinal acceleration a_{x,roh} and lateral acceleration a_{y,roh} are adjusted for contributions originating from the acceleration due to gravity and the inertial forces.

The inertial forces include the Coriolis force, the centripetal force and the Euler force and can be determined using the measured values of a rotation rate sensor. The yaw rate, i.e. the rotation rate of the vehicle 1, can alternatively also be derived from wheel speeds and/or from the wheel rotational speeds of the wheels of the vehicle 1. The measured values adjusted for the acceleration due to gravity can be determined by means of a Kalman filter from measured status data of the vehicle 1, in particular the speed, acceleration and/or rotation rate. In particular, the acceleration due to gravity is calculated using the Kalman filter. This can then be subtracted from the measured values in order to advantageously obtain the measured values adjusted for the acceleration due to gravity.

Furthermore, the coefficients Φ₀, Φ₁, Φ₂, Θ₀, Θ₁, Θ₂ of the polynomials are updated with the adjusted measured values MW in the respective iteration stage IS1 to ISn.

The solution described is based in particular on the idea that the relationship between the pitch angle Φ and the longitudinal acceleration a_{x,roh} or between the roll angle Θ and the lateral acceleration a_{y,roh} of the vehicle 1 can be specified in good approximation in the form of polynomials:

$$Φ ( {a}_{x , r o h} ) = {Φ}_{0} + {Φ}_{1} * {a}_{x , r o h} + {Φ}_{2} * {a}_{x , roh}^{2} + … \qquad ( 1 )$$

$$Θ ( {a}_{y , r o h} ) = {Θ}_{0} + {Θ}_{1} * {a}_{y , r o h} + {Θ}_{2} * {a}_{y , roh}^{2} + … \qquad ( 2 )$$

Here, Φ₀, Θ₁, Φ₂, Θ₀, Θ₁, Θ₂ represent the coefficients of the polynomials Φ(a_{x,roh}), Θ(a_{y,roh}) and a_{x,roh}, a_{y,roh} represent the unadjusted measured values MW of the longitudinal and lateral acceleration.

For the purpose of the solution described here, it is sufficient to use second-order polynomials. The following polynomials are therefore used for the calculations:

$$Φ ( {a}_{x , r o h} ) = {Φ}_{0} + {Φ}_{1} * {a}_{x , r o h} + {Φ}_{2} * {a}_{x , roh}^{2} \qquad ( 3 )$$

$$Θ ( {a}_{y , r o h} ) = {Θ}_{0} + {Θ}_{1} * {a}_{y , r o h} + {Θ}_{2} * {a}_{y , roh}^{2} \qquad ( 4 )$$

However, it is also possible to use first-order polynomials or third-order or higher-order polynomials.

The coefficients of the polynomials are optimized iteratively in the individual iteration stages IS1 to ISn, starting from predefined initial values, i.e. the system learns step by step which coefficients are optimal. For this purpose, an error value is calculated as follows:

a_{z,err}=a_{z}−Φ(a_{x,roh})*aₓ−Θ(a_{y,roh})*a_{y} (5)

With the second-order polynomials used, the result is then

$${a}_{z , err} = {a}_{z} - ( {Φ}_{0} + {Φ}_{1} * {a}_{x , r o h} + {Φ}_{2} * {a}_{x , roh}^{2} ) * {a}_{x} - ( {Θ}_{0} + {Θ}_{1} * {a}_{y , r o h} + {Θ}_{2} * {a}_{y , roh}^{2} ) * {a}_{y} \qquad ( 6 )$$

Here, a_{x,roh}, a_{y,roh} represent the unadjusted measured values MW of the longitudinal or lateral acceleration and aₓ, a_{y}, a_{z} represent the measured values of the acceleration adjusted for the acceleration due to gravity and the inertial forces.

The following delta coefficients are then formed using the error value a_{z,err}:

ΔΦᵢ=a_{z,err}*aⁱ_{x,roh}*aₓ; i=0,1,2 (7)

ΔΘᵢ=a_{z,err}*aⁱ_{y,roh}*a_{y}; i=0,1,2 (8)

The coefficients of the polynomials are then updated as follows:

Φᵢ=Φᵢ+LR_{Φ}_{ᵢ}*ΔΦᵢ; i=0,1,2 (9)

Θᵢ=Θᵢ+LR_{Θ}_{ᵢ}*ΔΘᵢ; i=0,1,2 (10)

where LR_{Φ}_{ᵢ}, LR_{Θ}_{ᵢ} are predefined update values (learning rates).

This updating of the coefficients is preferably only carried out at driving speeds that lie within a specified speed range, for example in the range from 0 km/h to 100 km/h.

In the respective iteration stage IS1 to ISn, it is checked whether the zero-order coefficients Φ₀, Θ₀ of the polynomials each fulfill a predefined convergence criterion. For example, it is determined whether the maximum deviation between the values of the coefficient Φ₀ determined within a predefined time period and the maximum deviation between the values of the coefficient Θ₀ determined within the predefined time period is less than a predefined limit value in each case.

If the zero-order coefficients Φ₀, Θ₀ do not fulfill the respective convergence criterion, the coefficients Φ₀, Φ₁, Φ₂, Θ₀, Θ₁, Θ₂ of the polynomials are output to the next iteration stage IS2 to ISn. Otherwise, i.e. if the zero-order coefficients Φ₀, Θ₀ fulfill the respective convergence criterion, the iterations are terminated.

At the end of the iterations, the zero-order coefficients Φ₀, Θ₀, i.e. the last determined values of the zero-order coefficients Φ₀ and Θ₀, are output as the results of the determined misorientation of the sensor coordinate system.

These determined values of the zero-order coefficients Φ₀, Θ₀ correspond to the static pitch angle Φ or the static roll angle Θ and represent the misalignment of the sensor coordinate system in relation to the pitch axis Y_{V} or roll axis X_{V} of the vehicle coordinate system.

With the determined misorientations, i.e. with the static pitch angle Φ and the static roll angle Θ, i.e. with the last determined zero-order coefficients Φ₀, Θ₀, a coordinate transformation matrix R is created as follows:

$$R = ( \begin{matrix}cos ( {Θ}_{0} ) & s in ( {Θ}_{0} ) sin ( {Φ}_{0} ) & s in ( {Θ}_{0} ) cos ( {Φ}_{0} ) \\ 0 & cos ( {Φ}_{0} ) & - s in ( {Φ}_{0} ) \\ - s in ( {Θ}_{0} ) & cos ( {Θ}_{0} ) sin ( {Φ}_{0} ) & cos ( {Θ}_{0} ) cos ( {Φ}_{0} )\end{matrix} ) \qquad ( 11 )$$

The coordinate transformation matrix R is used to convert the three-dimensional components of the acceleration determined in the sensor coordinate system into the vehicle coordinate system. In this way, the inertial measurement unit 2 is calibrated, i.e. measurement errors caused by the misalignment of the sensor coordinate system are compensated for.

In particular, the method described is only carried out if there is no large static pitch angle Φ of the vehicle 1 other than the rest position, as this would be included in the sensor orientation learning. For example, information from a rear level sensor and/or other chassis components of the vehicle 1 is used to detect static pitching situations, i.e. a static pitching angle Φ of the vehicle 1 above a predefined limit value, and to pause the procedure in such phases.

### LIST OF REFERENCES

1 vehicle
2 inertial measurement unit
IS1 to ISn iteration level
MW measured value
P parameters
X x-axis sensor coordinate system
Y y-axis sensor coordinate system
Z z-axis sensor coordinate system
X_{V} roll axis
Y_{V} pitch axis
Z_{V} yaw axis
Θ roll angle
Φ pitch angle
Ψ yaw angle

1-8. (canceled)

9. A method for determining a misorientation of an inertial measuring unit of a vehicle, by means of which three-dimensional components of an acceleration of the vehicle are measured in a sensor coordinate system, wherein
a vehicle coordinate system is specified for the vehicle, which has an x-axis in the longitudinal direction of the vehicle, a y-axis in the transverse direction of the vehicle and a z-axis in the vertical direction of the vehicle,
a misorientation of a plane spanned between an x-axis and a y-axis of the sensor coordinate system is determined with respect to a plane spanned between the x-axis and the y-axis of the vehicle coordinate system
characterized in that
the misorientation is determined iteratively in a plurality of iteration stages during a driving operation of the vehicle,
the respective iteration stage uses as input values current measured values of a longitudinal acceleration and a transverse acceleration of the vehicle determined by the inertial measuring unit, the acceleration due to gravity, state data of the vehicle required for calculating inertial forces and coefficients of predetermined polynomials, which in each case represent an approximated relationship between the measured longitudinal acceleration and a pitch angle of the vehicle or between the measured lateral acceleration and a roll angle of the vehicle,
the inertial forces are calculated in the respective iteration stage, the measured values of the longitudinal acceleration and lateral acceleration are adjusted for contributions originating from the acceleration due to gravity and from the inertial forces, the coefficients of the polynomials are updated with the adjusted measured values of the longitudinal acceleration and lateral acceleration, and it is checked whether the zero-order coefficients of the polynomials in each case satisfy a predetermined convergence criterion,
the coefficients of the polynomials are output to the next iteration stage if the zero-order coefficients of the polynomials do not fulfill the respective specified convergence criterion,
the iterations are terminated if the zero-order coefficients of the polynomials fulfill the respective specified convergence criterion, and
at the end of the iterations, the zero-order coefficients of the polynomials are output as results of the determined misorientation of the sensor coordinate system.

10. The method according to claim 9, characterized in that the respective iteration stage receives a rotational speed, a rotational rate, a speed and/or wheel rotational speeds as the state data of the vehicle required for calculating the inertial forces.

11. The method according to claim 9, characterized in that the respective iteration stage receives coefficients of predetermined polynomials of first or second order.

12. The method according to claim 9, characterized in that a Coriolis force, a centripetal force and/or an Euler force are calculated as inertial forces.

13. The method according to claim 9, characterized in that the results of the determined misorientation of the sensor coordinate system are used to create a coordinate transformation matrix with which the three-dimensional components of the acceleration determined in the sensor coordinate system are converted into the vehicle coordinate system.

14. A vehicle, comprising
an inertial measuring unit, and
a device which is designed and set up for carrying out a method according to claim 9.

15. The vehicle according to claim 14,
characterized in that the device or at least one processing unit of the device is a component of the inertial measurement unit.

16. The vehicle according to claim 14,
characterized in that the device has sensors for determining the acceleration due to gravity and/or the status data of the vehicle required for calculating the inertial forces.
